(19) United States
(12) Patent Application Publication
(10) Pub. No.: US 2010/0027500 A1
(43) Pub. Date: Feb. 4, 2010

(54) Transmission pattern for the transmission of data in a radio communications system

(76) Inventors: Egon Schulz, Munchen (DE); Wolfgang Zirwas, Munchen (DE)

Correspondence Address: STAAS & HALSEY LLP, SUITE 700, 1201 NEW YORK AVENUE, N.W., WASHINGTON, DC, 20005, US

(21) Appl. No.: 12/309,262

(22) PCT Filed: Jul. 5, 2007
(86) PCT No.: PCT/EP2007/056809

§ 371 Date: Oct. 8, 2009

(30) Foreign Application Priority Data
Jul. 13, 2006 (DE) 10 2006 032 495.1

(51) Int. Cl. H04W 40/00

(52) U.S. Cl. 370/330

(57) ABSTRACT

A method for the transmission of data between base stations and terminal devices uses at least one first time-frequency-spectrum which contains a plurality of transmission resources. A transmission resource is defined by a section of the time-frequency-spectrum, which is formed by at least one subcarrier subdivided into time slots and by at least one time slot. As part of the method, data are transmitted between a base station and a terminal device in a frame on one transmission resource. The method is characterized in that the base station transmits the data in such a way that a combination of subcarriers and/or time slots of the transmission resource used for the transmission of the frame forms a transmission pattern characterizing the nature of the data. The base station selects the transmission pattern from a number of previously defined transmission patterns, depending on the nature of the data to be transmitted.

### CROSS REFERENCE TO RELATED APPLICATIONS

This application is based on and hereby claims priority to German Application No. 10 2006 032 495.1 filed on Jul. 13, 2006 and PCT Application No. PCT/EP2007/056809 filed on Jul. 5, 2007, the contents of which are hereby incorporated by reference.

### BACKGROUND OF THE INVENTION

The invention relates to a method and apparatuses for avoiding interference in a cellular radio communication system.

In future cellular radio communication systems, particularly mobile radio communication systems such as the Universal Mobile Telecommunications System (UMTS), particular importance is attached to avoiding interference. Besides intracellular interference and intersector interference, the focus of avoiding interference is primarily avoiding intercell interference. In this case, taking the example of a mobile radio communication system with a plurality of base stations, interference between various cells can essentially be classified into two groups. A base station defines a radio cell. In proximity to the base station, which is the center of the radio cell, interference with broadcasts from a relatively large number of adjacent base stations occurs. Such interference in the first group is less intense in comparison with interference in the second group, however, for which interference the cell boundaries is considered. At the cell boundaries, interference with broadcasts from a very limited number of adjacent base stations occurs. However, the measured interference is much greater at the cell boundaries and has a much greater effect on the radio traffic in the cell than the interference from the first group, which occurs around the cell center.

Methods for avoiding interference in a cellular radio communication system are known which, when allocating radio resources (scheduling), take account of information about current interference in the radio communication system. This allows interference to be significantly reduced. A drawback of the known methods is, inter alia, the high complexity which arises on account of necessary interference measurements and also transmissions of the measured values between system components which are involved, however. In addition, if the scheduling is performed on the basis of allocation of subcarriers or chunks (time/frequency unit of a resource allocation), it is necessary to synchronize transmissions in the radio communication system.

If there is a constant traffic load in the radio communication system, it is possible to measure, for a terminal which requires one channel, for example, interference caused by adjacent cells for each chunk or for each subcarrier. Since the traffic load is constant, it is a simple matter to predict the next respective transmission frame, which means that the terminal can choose that transmission resource which has the least interference. Such a method is known as frequency dependent scheduling, for example.

Often, it is incorrect to assume a constant traffic load, however. In the case of packet-oriented transmission methods, for example, the actual traffic load in a radio communication system is almost impossible to predict. Methods for limiting the scope of action of a scheduler have been proposed for such systems, but these entail great drawbacks such as a great loss of flexibility and a high management complexity.

Another problem is that resource allocation based on past transmissions cannot take account of the fact that the traffic load for the period of the next transmission in line may have changed completely.

### SUMMARY

One potential object is to configure a method and apparatuses such that efficient resource allocation in a radio communication system becomes possible while largely avoiding intercell interference.

The inventors propose a method for transmitting data between base stations and terminals in a radio communication system. The method uses at least one first time/frequency spectrum, the at least one time/frequency spectrum containing a plurality of transmission resources. A transmission resource is defined by a detail from the time/frequency spectrum, formed by at least one subcarrier, divided into time slots, and at least one time slot. The method involves data being transmitted between a base station and a terminal in a frame on a transmission resource.

The proposed method is characterized in that the base station transmits the data such that a combination of subcarriers, used for transmitting the frame, and/or time slots used in the transmission resource forms a transmission pattern characterizing the nature of the data. In this case, the base station selects the transmission pattern from a set of previously defined transmission patterns on the basis of the nature of the data which are to be transmitted.

Another form of the proposed method is characterized in that for allocating a transmission resource for transmitting data between a first base station and a terminal, the terminal ascertains, for each transmission resource to which the terminal has access, a measured value characterizing the channel quality of the respective transmission resource and transmits it to the first base station. In addition, for each transmission resource to which the terminal has access, the terminal ascertains a transmission pattern which is used by an adjacent base station using the respective transmission resource. The transmission pattern is formed by a combination of subcarriers, used for the transmission of the adjacent base station, and/or time slots used in the transmission resource, wherein the transmission pattern characterizes the nature of the data, and wherein the adjacent base station selects the transmission pattern from a set of previously defined transmission patterns on the basis of the nature of the data which are to be transmitted. For each transmission resource to which the terminal has access, in addition to the ascertained measured value characterizing the channel quality of the respective transmission resource, the terminal transmits the ascertained transmission pattern to the first base station. The first base station allocates the terminal a suitable transmission resource on the basis of the transmitted measured values and transmission patterns in respect of the transmission resources to which the terminal has access.

The inventors propose a base station and a terminal for carrying out the method, a transmission pattern and an appropriate radio communication system.

The methods and devices afford the advantage that intercell interference is avoided without the need for separate synchronization or signaling between base stations. Rather, the interference is avoided locally on the basis of measurements of transmission patterns which are performed by terminals. The likelihood of intercell interference is therefore significantly reduced.

The proposed method requires no additional resources apart from those for transmitting the useful data, since no direct signaling takes place. Instead, the engagement of a transmission resource over time and frequency is used indirectly to signal the likelihood of the relevant transmission resource being engaged in future.

Those components of the relevant transmission resource which are not used on account of the choice of a transmission pattern for the transmission of data between a first base station and a first terminal can be used for the other terminals. This is particularly the case since the other terminals are usually situated at a different location than the first terminal and hence have a different attenuation. Another terminal in a neighboring cell is therefore able to recognize the transmission pattern used by the first base station despite the fact that other terminals are using the components of the transmission resource which are not used by the first base station.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows an example scenario with two base stations and two terminals,

FIG. 2 shows transmission resources and transmission patterns in the example scenario,

FIG. 3 shows allocation of the transmission resources in the example scenario,

FIG. 4 shows an example scenario of use of unused resources in transmission patterns.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

Traffic classes are defined, wherein a traffic class represents a particular nature of data to be transmitted. By way of example, these traffic classes are defined on the basis of the length of data packets associated with the transmission and on the basis of a likelihood of a transmission lasting a plurality of frames given a constant volume of data per data packet. In this case, the traffic classes can be derived both from the volume of data which actually needs to be transmitted per packet and from the type of an application. Examples of different applications are voice calls (constant traffic, small volumes of data) or video streaming (constant traffic, large volumes of data). Each traffic class is represented by a transmission pattern which characterizes the nature of the data to be transmitted. The transmission pattern is produced by virtue of transmission of data on a transmission resource between a base station and a terminal involving the base station transmitting the data such that a combination of subcarriers, used for transmitting the frame, and/or time slots used in the transmission resource forms a transmission pattern characterizing the nature of the data. In this case, the base station selects the transmission pattern from a set of previously defined transmission patterns on the basis of the nature of the data to be transmitted. For a voice call, the base station therefore chooses a different transmission pattern than for a video streaming call.

When a terminal requires a channel, the terminal proceeds as follows: to allocate a transmission resource for transmitting data between a first base station and a terminal, the terminal transmits, for each transmission resource (res1, res2) to which the terminal has access, a measured value identifying the channel quality of the respective transmission resource (res1, res2) to the first base station, for example a channel quality indicator, which represents the signal-to-noise-plus-interference ratio. In addition, the terminal ascertains, for each transmission resource (res1, res2) to which the terminal has access, a transmission pattern (p1, p2) which is used by an adjacent base station using the respective transmission resource (res1, res2). Next, for each transmission resource to which it has access, the terminal sends the ascertained channel quality indicator and the respectively ascertained transmission patterns (p1, p2) to the first base station. On the basis of the transmitted measured values and transmission patterns (p1, p2) in respect of the transmission resources (res1, res2) to which the terminal has access, the first base station allocates the terminal a suitable transmission resource (res1, res2).

Hence, when there are one or more adjacent base stations providing a high level of interference, the method allows a prediction about the nature of the impending transmission, for the next respective frame, by the adjacent base stations on the transmission resources to which the terminal has access. It is of no consequence which adjacent base station has a particular likelihood, as a result of the respective transmission pattern, of sending on which transmission resource. Together with the measurement of current interference, for example in the course of ascertainment of the signal-to-noise-plus-interference ratio, the individual base station can select and allocate a suitable transmission resource for the terminal on the basis of the list of possible transmission resources which is transmitted by the terminal and the transmission patterns used by the adjacent base stations.

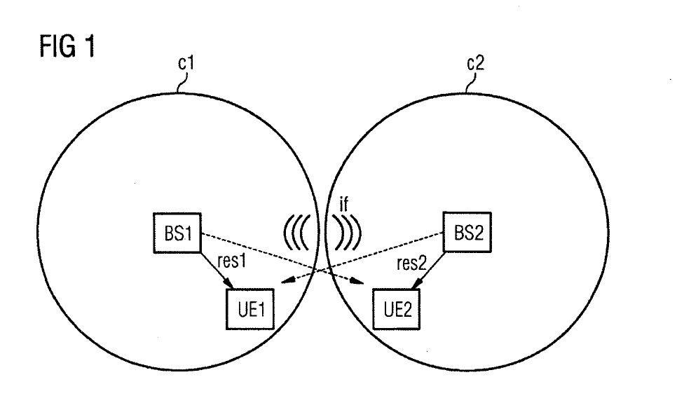

FIG. 1 shows an example scenario with two adjacent base stations BS1, BS2 and two terminals UE1, UE2. A first base station BS1 defines a first radio cell c1, a second base station B2 defines a second radio cell c2, which is adjacent to the first radio cell c1. The first base station BS1 transmits data on a first transmission resource res1 to a first terminal UE1, the second base station BS2 transmits data on a second transmission resource res2 to a second terminal UE2. The terminals UE1, UE2 are each situated at the cell boundaries of the radio cells c1, c2. The physical proximity of the terminals UE1, UE2 and the transmissions sent to them on the transmission resources res1, res2 mean that intercell interference if is produced at the cell boundaries.

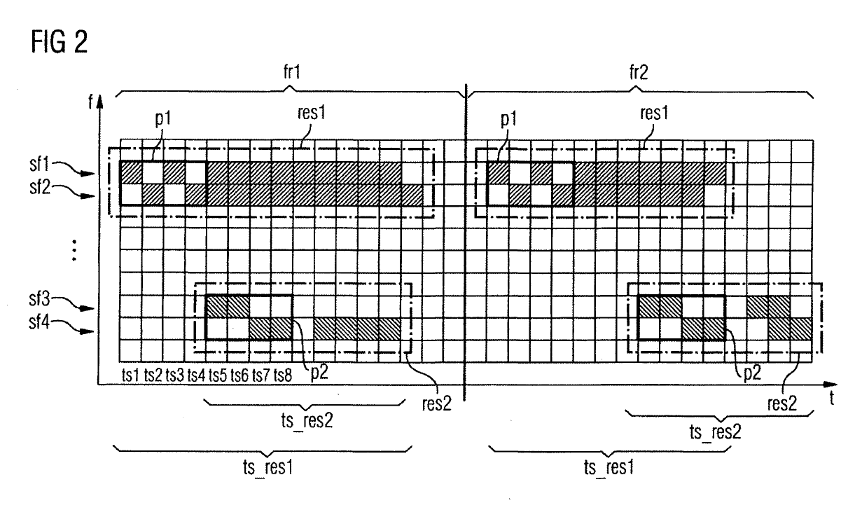

FIG. 2 shows an example of transmission resources res1, res2 and transmission patterns p1, p2 for the example scenario shown in FIG. 1. The x axis plots the time t, the y axis plots the frequency f. The division of the coordinate system shown corresponds to a classification into time slots (x axis) and subcarriers (y axis). The scenario shown is a time period with two frames fr1, fr2, within which data are transmitted from a first base station to a first terminal on a first transmission resource res1. In parallel, a second base station transmits data to a second terminal on a second transmission resource res2. The first transmission resource res1 is formed by a first and a second subcarrier sf1, sf2 and also by a first group of time slots ts_res1. The second transmission resource res2 is formed by a third and a fourth subcarrier sf3, sf4 and also by a second group of time slots ts_res2. The time slots in the first group of time slots ts_res1 and also the time slots in the second groups of time slots ts_res2 largely overlap one another. The first and second subcarriers sf1, sf2 are arranged adjacently in the frequency band f, the third and fourth subcarriers sf3, sf4 are likewise adjacent. The first base station transmits a large volume of data to the first terminal, whereas the second base station transmits a small volume of data to the second terminal. The first base station transmits the data in a first frame fr1 on the first transmission resource res1 such that a first transmission pattern p1 is formed. The first transmission pattern p1 is produced by virtue of the first base station transmitting the data in a first time slot ts1 using the first subcarrier sf1 and in a second time slot ts2 using the second subcarrier sf2. For a third and a fourth time slot ts3, ts4, the first base station repeats this manner of the transmission, so that the first transmission pattern p1 is obtained as shown in FIG. 2. The first base station has selected the first transmission pattern p1 from a set of transmission patterns prior to the start of the transmission of the data on the basis of the nature of the data which are to be transmitted. In the example shown, the first transmission pattern p1 corresponds to a large volume of data to be transmitted, the transmission of which has a high likelihood of being continued in a second frame fr2, which follows the first frame fr1, too.

A corresponding situation applies to the second base station: The second base station transmits data in the first frame fr1 on the second transmission resource res1, which extends over the second group of time slots ts_res2 and the third and fourth subcarriers sf3, sf4. In contrast to the data transmitted by the first base station, the volume of data transmitted by the second base station is smaller. The second base station therefore chooses a second transmission pattern p2, which differs from the first transmission pattern p1, prior to transmission of the data. The second transmission pattern p2 is obtained by virtue of the second base station transmitting data on the third subcarrier sf3 during a fifth and a sixth time slot ts5, ts6 in order to subsequently transmit data on the fourth carrier sf4 during a seventh and an eighth time slot ts7, ts8. In the example shown, the second transmission pattern p2 formed in this manner characterizes a small volume of data, the transmission of which has a high likelihood of being continued in the second frame fr2, which follows the first frame fr1, too.

In the second frame fr2, the first base station in turn uses the first transmission pattern p1 for transmission, the second base station in turn uses the second transmission pattern p2 for transmission.

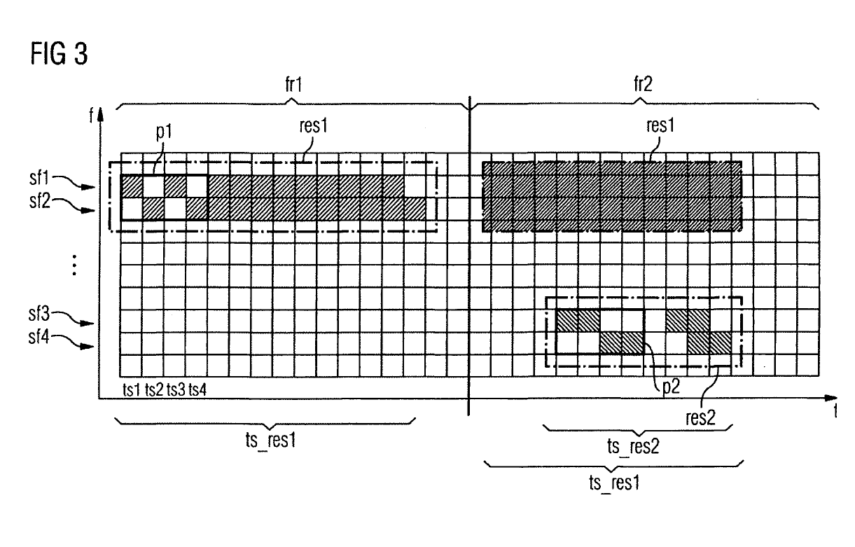

FIG. 3 shows the allocation of the transmission resources in the example scenario from FIG. 1. It is assumed that the first base station allocates the first terminal the first transmission resource res1. Since a large volume of data is transmitted both in the first frame fr1 and in the subsequent second frame fr2, the first base station chooses the first transmission pattern p1 for the transmission on the first transmission resource res1 in the first and second frames fr1, fr2.

It is also assumed that the second terminal is intended to be allocated a suitable transmission resource by the second base station of the second frame fr2. To this end, the second terminal first of all measures, for each transmission resource to which the second terminal has access, a measured value identifying the channel quality of the respective transmission resource, for example a channel quality indicator, which represents the signal-to-noise-plus-interference ratio. In addition, the second terminal ascertains, for each transmission resource to which the second terminal has access, a transmission pattern which is used by an adjacent base station using the respective transmission resource. In the example shown in the figures, the second terminal ascertains the first transmission pattern p1 for the first transmission resource res1, for example. This first transmission pattern p1, which is used by the first base station, identifies the transmission of a large volume of data for the current first frame fr1. In addition, the first transmission pattern p1 allows the inference that there is a high likelihood of a large amount of data being transmitted from the first transmission resource res1 in the subsequent second frame fr2 too, for example because the transmission by the first base station is a video screening application.

Next, the second terminal sends, for each transmission resource to which it has access, the ascertained channel quality indicator and also the respective ascertained transmission pattern, particularly the transmission pattern p1 for the first transmission resource p1, to the second base station. On the basis of the transmitted measured values and transmission patterns in respect of the transmission resources to which the second terminal has access, the second base station allocates the second terminal a suitable transmission resource, in the example shown the second transmission resource res2 for the second frame fr2.

This avoids disruptive intercell interference in the cell boundary region. Without taking account of the first transmission pattern p1, the second base station would not be able to make a statement about a likely future resource engagement by the first transmission resource res1. In the worst case, the second base station would then allocate the second terminal the first transmission resource res1, even though the first base station in the adjacent radio cell is already transmitting large volumes of data on this first transmission resource res1. Highly disruptive intercell interference would be the inevitable result. The proposed method effectively avoids this without the need for direct signaling or other complex synchronization between the first and the second base station.

Alternatively, the second terminal sends the ascertained channel quality indicator and also the respective ascertained transmission pattern to the second base station only for a selection of transmission resources to which the second terminal has access. By way of example, these may be the transmission resources which are ascertained by the second terminal as the best transmission resources.

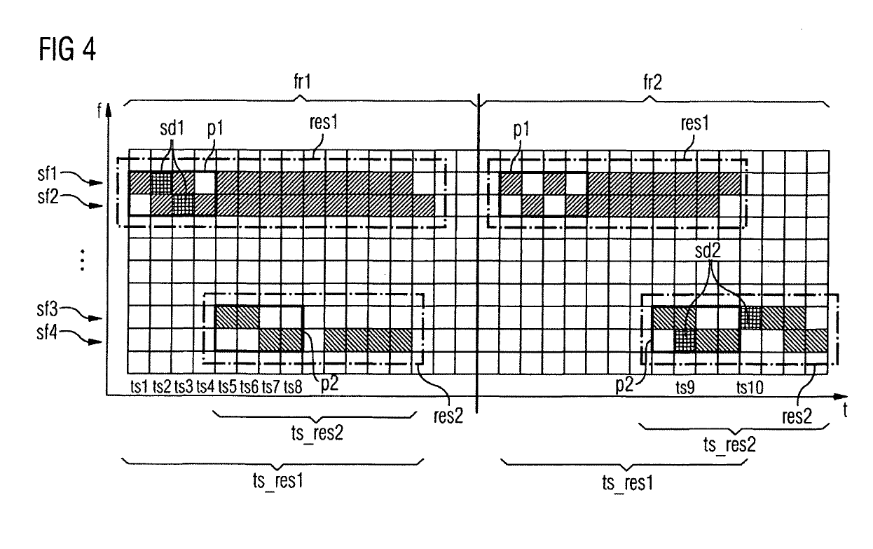

FIG. 4 shows for the example scenario how, on the basis of the use of transmission patterns p1, p2, unused portions of the relevant transmission resources res1, res2 can be used by other terminals. In this case, it is assumed that although a third terminal, for example, is in one of the two radio cells defined by the first and second base stations and hence is engaged in portions of the transmission resources of the first or the second base station, the third terminal is usually at a different location than the first and second terminals and hence has a different attenuation than the first and second terminals. Transmissions between the first or the second base station and the third terminal therefore have no influence on the perception of the transmission pattern res1, res2 used by the first or second base station by a fourth terminal situated in an adjacent radio cell.

In the example shown in FIG. 4, the third terminal, which is in the first radio cell of the first base station, for example, is allocated the second time slot ts2 in a first subcarrier sf1 and the third time slot ts3 in a second subcarrier sf2 of the first transmission resource res1, these portions of the first transmission resource res1 being those portions of the first transmission resource res1 which are unused on the basis of the first transmission pattern p1. The first short data sd1 to be transmitted on these portions of the first transmission resource res1 are in this case only a small volume of data, for example short messages which can be transmitted in one or two time slots.

A corresponding situation applies to the second short data sd2 likewise shown in FIG. 4. In the examples shown, these are transmitted in a ninth time slot ts9 on the fourth subcarrier sf4 and in a tenth time slot ts10 on the third subcarrier sf3.

The transmission patterns p1, p2 shown in the figures are merely two possible variants. Other combinations, for example based on just one subcarrier for a plurality of successive time slots or else on a larger number of subcarriers than in the example shown, are conceivable.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-8. (canceled)

9. A method for transmitting data over a time/frequency spectrum between base stations and terminals in a radio communication system, the time/frequency spectrum being divided into a plurality of subcarriers and being divided into a plurality of time slots, the time/frequency spectrum being further divided into frames, each frame comprising a plurality of time slots, the method comprising:
selecting a transmission pattern to transmit data in a frame from a base station to a terminal, the transmission pattern being a combination of subcarriers and time slots, the transmission pattern being selected from a set of previously defined transmission patterns based on a nature of the data to be transmitted; and
transmitting the data using the selected transmission pattern as a transmission resource.

10. The method as claimed in claim 9, wherein
the time slots for the transmission pattern are chosen before any data is transmitted in said frame.

11. The method as claimed in claim 9, wherein the transmission pattern allows a prediction of an expected utilization of the transmission resource in a subsequent frame.

12. The method as claimed in claim 10, wherein the transmission pattern allows a prediction of an expected utilization of the transmission resource in a subsequent frame.

13. A method for allocating transmission resources for transmitting data between base stations and terminals in a radio communication system, each transmission resource occupying a subset of a time/frequency spectrum, the time/frequency spectrum being divided into subcarriers and being divided into time slots, the method comprising:
accessing at least one occupied transmission resource at a terminal;
ascertaining, for each transmission resource to which the terminal has access, a measured value identifying a channel quality of the respective transmission resource;
transmitting each measured value from the terminal to a first base station;
ascertaining a transmission pattern for each transmission resource to which the terminal has access and which is used for communication by a base station other than the first base station, the transmission pattern being formed by a combination of subcarriers and time slots, the transmission pattern characterizing a nature of the data being transmitted, the transmission pattern being selected from a set of previously defined transmission patterns based on the nature of the data to be transmitted;
transmitting each ascertained transmission pattern from the terminal to the first base station; and
allocating a transmission resource at the first base station for data transmission to the terminal, the transmission resource being allocated based on the measured values and transmission patterns received from the terminal.

14. A base station comprising:
a transmitter to transmit data over a time/frequency spectrum to a terminal in a radio communication system, the time/frequency spectrum being divided into a plurality of subcarriers and being divided into a plurality of time slots, the time/frequency spectrum being further divided into frames, each frame comprising a plurality of time slots, the data being transmitted in a frame according to a transmission pattern; and
a controller to select the transmission pattern to transmit the data to the terminal, the transmission pattern being a combination of subcarriers and time slots, the transmission pattern being selected from a set of previously defined transmission patterns based on a nature of the data to be transmitted.

15. A terminal comprising:
a receiver to receive data over a time/frequency spectrum from a base station in a radio communication system, the time/frequency spectrum being divided into a plurality of subcarriers and being divided into a plurality of time slots, the time/frequency spectrum being further divided into frames, each frame comprising a plurality of time slots, the data being received in a frame according to a transmission pattern; and
a processor to recognize the transmission pattern used to transmit data from the base station in the frame, the transmission pattern being a combination of subcarriers and time slots, the transmission pattern being selected from a set of previously defined transmission patterns based on a nature of the data to be transmitted.

16. A radio communication system comprising:
a base station comprising:
a transmitter to transmit data over a time/frequency spectrum to a terminal in a radio communication system, the time/frequency spectrum being divided into a plurality of subcarriers and being divided into a plurality of time slots, the time/frequency spectrum being further divided into frames, each frame comprising a plurality of time slots, the data being transmitted in a frame according to a transmission pattern; and
a controller to select the transmission pattern to transmit the data to the terminal, the transmission pattern being a combination of subcarriers and time slots, the transmission pattern being selected from a set of previously defined transmission patterns based on a nature of the data to be transmitted; and
a terminal comprising:
a receiver to receive data over the time/frequency spectrum from the base station, the data being received in a frame according to the transmission pattern; and
a processor to recognize the transmission pattern used to transmit data from the base station.
